(19) United States
(12) Patent Application Publication
(10) Pub. No.: US 2020/0033890 A1
(43) Pub. Date: Jan. 30, 2020

(54) METHOD FOR SETTING FLIGHT ALTITUDE OF UNMANNED AERIAL VEHICLE AND UNMANNED AERIAL VEHICLE SYSTEM

(71) Applicant: PRODRONE CO., LTD., Nagoya-shi, Aichi (JP)

(72) Inventor: Kiyokazu SUGAKI, Nagoya-shi (JP)

(73) Assignee: PRODRONE CO., LTD., Nagoya-shi, Aichi (JP)

(21) Appl. No.: 16/499,787

(22) PCT Filed: Jul. 9, 2018
(86) PCT No.: PCT/JP2018/025826

§ 371 Date: Sep. 30, 2019

(30) Foreign Application Priority Data
Jul. 10, 2017 (JP) 2017-134686

(51) Int. Cl. G05D 1/10; B64C 39/02; G05D 1/00

(52) U.S. Cl. CPC G05D 1/101; B64C 39/024; G05D 1/0088; B64C 2201/12; B64C 2201/042; B64C 2201/127; B64C 2201/141

(57) ABSTRACT

A method for setting a flight altitude and such an unmanned aerial vehicle system that efficiently set the flight altitude in a flight plan based on undulation and/or inclination of a ground surface or a ground object. The method includes: an undulation research step of making the unmanned aerial vehicle fly and measuring a height of a ground surface or a ground object; and an altitude setting step of, during preparation of a flight plan that is setting data including a specification of a path on which the unmanned aerial vehicle is made to fly autonomously, automatically setting the flight altitude on the path in the flight plan based on the height of the ground surface or the ground object measured in the undulation research step. An unmanned aerial vehicle system capable of performing the method.

### TECHNICAL FIELD

The present invention relates to an unmanned aerial vehicle technique.

### BACKGROUND ART

Patent literature 1 below discloses a model aerial vehicle that automatically keeps its flight altitude at a set flight altitude.

### CITATION LIST

### Cited Literature

PTL1: JP 5-317528 A

### SUMMARY OF INVENTION

### Technical Problem

Small-size unmanned aerial vehicles represented by multi-copters are equipped with a control device referred to as a flight controller to control flight motions of the airframe. Some of the flight controller products on the market are equipped with an autopilot function. The autopilot function refers to a function that automatically maintains the posture and/or the flight position of an unmanned aerial vehicle and/or that makes an unmanned aerial vehicle fly autonomously based on a flight plan prepared by an operator. In a typical autopilot flight plan, it is possible to specify, for example: a landing and take-off point for the airframe; longitude and latitude of a flight route; altitude; speed; and the azimuth angle of the airframe nose. Otherwise, some flight controllers dedicated to aerial photography are capable of specifying, for example: when to start and end photographing with a camera; and PTZ motions of a camera.

In order to control the flight altitude of the airframe during a flight, the above kind of flight controller is provided with image recognition means that uses: a pneumatic sensor; a distance measuring sensor utilizing laser and/or ultrasonic; or a camera.

In control using a pneumatic sensor, the flight altitude is determined based on air pressure altitude, instead of ground altitude. Therefore, heights of ground surfaces and ground objects are not taken into consideration. Under the circumstances, when, for example, an unmanned aerial vehicle is made to fly along an inclination of a mountain surface, it is necessary to research in advance undulation of the mountain surface and manually specify flight altitudes, one by one, on the flight path. In this respect, when contour lines on a map are relied upon in specifying flight altitudes, since contour lines on a map only provide approximate heights, it is impossible to prepare, for example, a flight plan that makes the unmanned aerial vehicle fly while maintaining a 5-m distance between the unmanned aerial vehicle and a mountain surface. In contrast, in order to measure a mountain surface in detail in advance, large-scale work is involved, resulting in cost-related problems. Further, measurement data becomes obsolete through the passage of time, and thus it is necessary to repeat measurements, depending on the accuracy required of measurement data.

When a distance measuring sensor or image recognition means is used, flight altitude can be controlled based on relative distance on an individual ground-surface basis or on an individual ground-feature basis. In this case, however, when the unmanned aerial vehicle is made to fly in a region in which trees stand together in large numbers, the relative distance fluctuates in a narrow range, causing a problem of instable flight altitudes.

Also, with any of the above-described altitude control means, in order to circumvent an obstacle located beyond the unmanned aerial vehicle on the flight path, it is necessary to implement an additional measure against the obstacle.

In light of the above-described problems, a problem to be solved by the present invention is to provide such a method for setting a flight altitude and such an unmanned aerial vehicle system that efficiently set the flight altitude in a flight plan based on undulation and/or inclination of a ground surface or a ground object.

### Solution to Problem

In order to solve the above-described problem, the present invention provides a method for setting a flight altitude of an unmanned aerial vehicle. The method includes: an undulation research step of making the unmanned aerial vehicle fly and measuring a height of a ground surface or a ground object; and an altitude setting step of, during preparation of a flight plan that is setting data including a specification of a path on which the unmanned aerial vehicle is made to fly autonomously, automatically setting the flight altitude on the path in the flight plan based on the height of the ground surface or the ground object measured in the undulation research step.

In the undulation research step, the unmanned aerial vehicle is made to fly, and the height of a ground surface or a ground object is measured. This ensures that a flight altitude is set based on the actual shape of the ground over which the unmanned aerial vehicle is currently flying. Then, in the altitude setting step according to the present invention, the flight altitude in a flight plan is set automatically based on the measurement result obtained in the undulation research step. This saves an operator the labor of calculating and inputting an optimum flight altitude. Also, the present invention is under the assumption that the unmanned aerial vehicle is made to fly autonomously based on the flight plan prepared in the altitude setting step and to perform some kind of work. Prior to the work, the unmanned aerial vehicle is also used to measure the height of the ground surface or the ground object. This eliminates the need for preparing an additional measuring instrument and/or a related instrument to measure the height of the ground surface or the ground object. Thus, the method according to the present invention eliminates labor and cost problems associated with measurement work, and eliminates the problem that measurement data becomes obsolete through the passage of time. Further, undulations and/or inclinations that are as small as a few to several meters in size and that cannot be found on a map or something similar are found on-site, ensuring that flight altitudes more suitable for actual situations are set.

Preferably, the undulation research step includes measuring the height of the ground surface or the ground object based on: a sea level altitude obtained using an altitude sensor with which the unmanned aerial vehicle is equipped or a relative altitude measured from a take-off point of the unmanned aerial vehicle and obtained using the altitude sensor; and a ground altitude obtained using a distance measuring sensor or image pickup means facing downward from the unmanned aerial vehicle.

Thus, the unmanned aerial vehicle includes an altitude sensor and a distance measuring sensor or image pickup means. This ensures that the height of the ground surface or the ground object on the flight path can be calculated by subtracting the ground altitude from the relative altitude from the take-off point or the sea level altitude. Thus, the height of the ground surface or the ground object is easily identified. Further, these two altitudes are used to control the flight altitude of the unmanned aerial vehicle while the unmanned aerial vehicle is flying. This improves the accuracy of controlling the flight altitude.

Preferably, the method according to the present invention for setting the flight altitude of the unmanned aerial vehicle further includes a temporary path setting step of preparing a flight plan in which the path on which the unmanned aerial vehicle is made to fly autonomously is specified such that the flight altitude is provided with an allowance relative to the height of the ground surface or the ground object on the path. Preferably, the undulation research step includes making the unmanned aerial vehicle fly autonomously based on the flight plan prepared in the temporary path setting step and measuring the height of the ground surface or the ground object on the path in the flight plan.

In order to use in the altitude setting step the measurement result obtained in the undulation research step, it is necessary that the height of the ground surface or the ground object on the path specified in the altitude setting step has already been measured. That is, in the undulation research step, it is necessary to make the airframe fly on the path to be specified in the altitude setting step; to make the airframe do this by manual operation, skillful pilotage is required. In this respect, it is possible to operate the airframe while checking longitude and latitude values of telemetry data on the control device at hand. This method, however, is not an efficient method. Under the circumstances, a flight plan in which the flight altitude is provided with an allowance is prepared, and the flight plan is used to implement an autonomous flight in the undulation research step. This ensures that the height of the ground surface or the ground object on the path specified in the altitude setting step is measured more efficiently.

Preferably, the path in the flight plan prepared in the temporary path setting step and the path in the flight plan prepared in the altitude setting step are approximately identical to each other in longitude and latitude.

The longitude and latitude of the path in the flight plan prepared in the temporary path setting step, that is, the longitude and latitude of the path on which the unmanned aerial vehicle is made to fly in the undulation research step are approximately identical to the longitude and latitude of the path specified in the altitude setting step. This ensures that the range of measurement performed in the undulation research step can be narrowed down to a range of measurement performed in actual situations. This makes the undulation research step efficient and widens the coverage of the range automatically settable in the altitude setting step.

Preferably, the method according to the present invention for setting the flight altitude of the unmanned aerial vehicle further includes a target distance setting step of specifying a target distance that is a ground altitude for the unmanned aerial vehicle to maintain. Preferably, the altitude setting step includes automatically setting, as the flight altitude on the path in the flight plan, a height obtained by adding the target distance to the height of the ground surface or the ground object measured in the undulation research step.

Thus, the target distance between the ground surface or the ground object and the unmanned aerial vehicle is specified in a desired manner based on the work in which the unmanned aerial vehicle is engaged. This makes the method according to the present invention usable in a wide range of applications.

Preferably, the method according to the present invention for setting the flight altitude of the unmanned aerial vehicle further includes: an undulation re-research step of making the unmanned aerial vehicle fly autonomously based on the flight plan prepared in the altitude setting step and measuring the height of the ground surface or the ground object on the path in the flight plan; and an altitude re-setting step of automatically setting, as the flight altitude on the path in the flight plan, a height obtained by adding the target distance to the height of the ground surface or the ground object measured in the undulation re-research step.

If the measurement in the undulation research step is performed only once, it is possible that the flight altitude that has been set is not sufficiently accurate, depending on the accuracy of measurement performed in the undulation research step. Under the circumstances, the flight plan prepared in the altitude setting step is used again to measure the height of the ground surface or the ground object. This ensures that a measurement result higher in accuracy than the previous measurement result is obtained. Then, a flight plan is prepared based on the measurement result obtained. This ensures that a more ideal flight altitude is set.

Preferably, a path along an inclined surface is specified in the flight plan prepared in the altitude setting step.

The present invention easily facilitates an autonomous flight along an inclined surface, which is difficult to implement with a typical flight controller product.

In order to solve the above-described problem, the present invention provides an unmanned aerial vehicle system that includes: an unmanned aerial vehicle; and a control device configured to prepare a flight plan that is setting data including a specification of a path on which the unmanned aerial vehicle is made to fly autonomously. The unmanned aerial vehicle or the control device includes: autonomous flight control means for making the unmanned aerial vehicle fly autonomously based on the flight plan; and undulation obtaining means for calculating a height of a ground surface or a ground object on the path on which the unmanned aerial vehicle has been made to fly. The control device includes altitude setting means for, during preparation of the flight plan, automatically setting a flight altitude of the unmanned aerial vehicle on the path in the flight plan based on the height of the ground surface or the ground object calculated by the undulation obtaining means.

The unmanned aerial vehicle system according to the present invention includes undulation obtaining means for calculating the height of the ground surface or the ground object. This ensures that the flight altitude of the unmanned aerial vehicle is set based on the actual shape of the ground along which the unmanned aerial vehicle is made to fly. Then, based on the calculation result obtained by the undulation obtaining means, the altitude setting means automatically sets the flight altitude in the flight plan. This saves the operator the labor of calculating and inputting an optimum flight altitude. Also, the present invention is under the assumption that the unmanned aerial vehicle is made to fly autonomously based on the flight plan in which the flight altitude has been set by the altitude setting means and to perform some kind of work. Prior to the work, the unmanned aerial vehicle is also used to measure the height of the ground surface or the ground object. This eliminates the need for preparing an additional measuring instrument and/or a related instrument to measure the height of the ground surface or the ground object. Thus, the unmanned aerial vehicle system according to the present invention eliminates labor and cost problems associated with measurement work, and eliminates the problem that measurement data becomes obsolete through the passage of time. Further, undulations and/or inclinations that are as small as a few to several meters in size and that cannot be found on a map or something similar are found on-site, ensuring that flight altitudes more suitable for actual situations are set.

Preferably, the unmanned aerial vehicle includes: an altitude sensor configured to obtain a sea level altitude or a relative altitude measured from a take-off point; and distance information obtaining means for obtaining information from which a distance to the ground surface or the ground object is measurable. Preferably, the unmanned aerial vehicle or the control device includes distance measuring means for calculating a ground altitude of the unmanned aerial vehicle from the information obtained by the distance information obtaining means. Preferably, the undulation obtaining means is configured to calculate the height of the ground surface or the ground object based on the sea level altitude or the relative altitude from the take-off point obtained by the altitude sensor and based on the ground altitude obtained by the distance measuring means.

Thus, the unmanned aerial vehicle includes an altitude sensor and distance measuring means. This ensures that the height of the ground surface or the ground object on the flight path can be calculated by subtracting the ground altitude from the relative altitude from the take-off point or the sea level altitude. Thus, the height of the ground surface or the ground object is easily identified.

Preferably, the control device includes target distance holding means for storing a target distance that is a ground altitude for the unmanned aerial vehicle to maintain. Preferably, the altitude setting means is configured to automatically set, as the flight altitude on the path in the flight plan, a height obtained by adding the target distance to the height of the ground surface or the ground object.

Thus, the target distance between the ground surface or the ground object and the unmanned aerial vehicle is specified in a desired manner based on the work in which the unmanned aerial vehicle is engaged. This makes the unmanned aerial vehicle system according to the present invention flexibly usable in a wide range of applications.

### Advantageous Effects of Invention

Thus, the method according to the present invention for setting a flight altitude and the unmanned aerial vehicle system according to the present invention efficiently set the flight altitude of the unmanned aerial vehicle relative to an undulation and/or an inclination of a ground surface or a ground object.

### BRIEF DESCRIPTION OF DRAWINGS

FIG. 1 is a schematic illustrating how agricultural chemical spraying work is performed using an unmanned aerial vehicle system.

FIG. 2 is a block diagram illustrating a functional configuration of a multi-copter.

FIG. 3 is a block diagram illustrating a functional configuration of a control device.

FIG. 4 is a flowchart of preparation of a flight plan.

FIG. 5 is a side sectional view of a part of the path cut out from FIG. 1.

FIG. 6 is a partially enlarged view of a part cut out from FIG. 5.

FIG. 7 illustrates how flight altitude is automatically set after height information on heights of trees such as fruit trees illustrated in FIG. 5 has been processed.

FIG. 8 is a schematic illustrating an example in which the unmanned aerial vehicle system of this example is used in another application.

### DESCRIPTION OF EMBODIMENTS

### [Embodiment Outlined]

An embodiment of the present invention will be described below (this embodiment will be hereinafter occasionally referred to as “this example”). This embodiment is an example in which work of spraying agricultural chemical over an orchard developed on an inclined surface at the foot of a mountain is performed using an unmanned aerial vehicle system S, which includes: a multi-copter 10, which is a small-size unmanned rotary-wing aerial vehicle; and a control device 60.

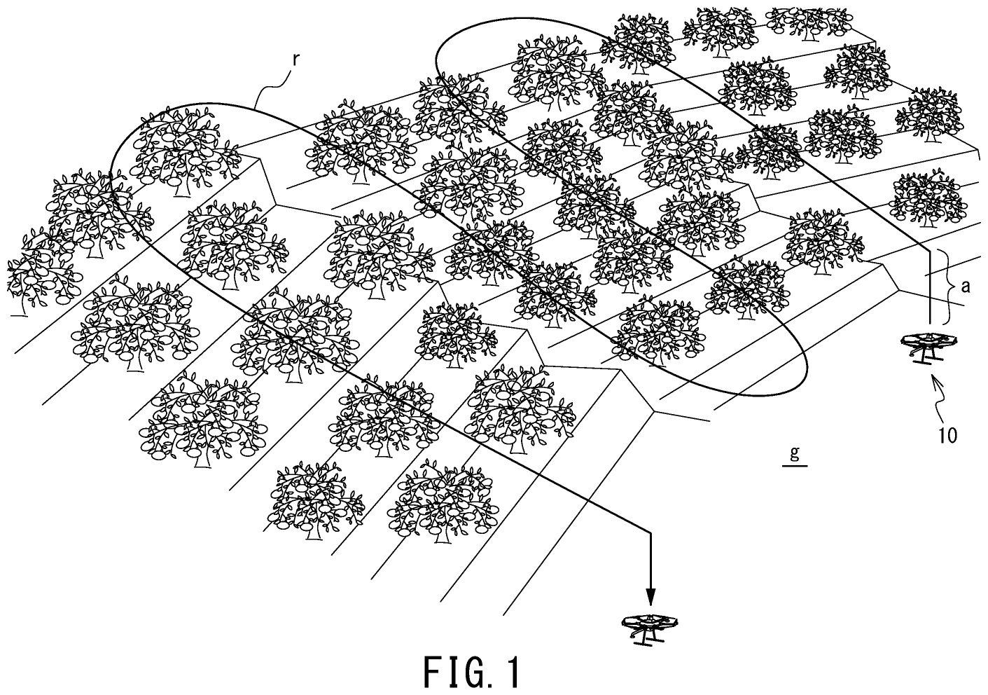

FIG. 1 is a schematic illustrating how agricultural chemical spraying work is performed using the unmanned aerial vehicle system S. In the agricultural chemical spraying work of this example, the multi-copter 10 autonomously flies at a predetermined flight along a path r, which is specified in advance, at an altitude a; and sprays agricultural chemical over a mountain surface, which is a ground surface, or over fruit trees, which are ground objects (these will be hereinafter collectively referred to as “fruit trees and related objects g”).

### [Functional Configuration]

### (Functional Configuration of Multi-Copter)

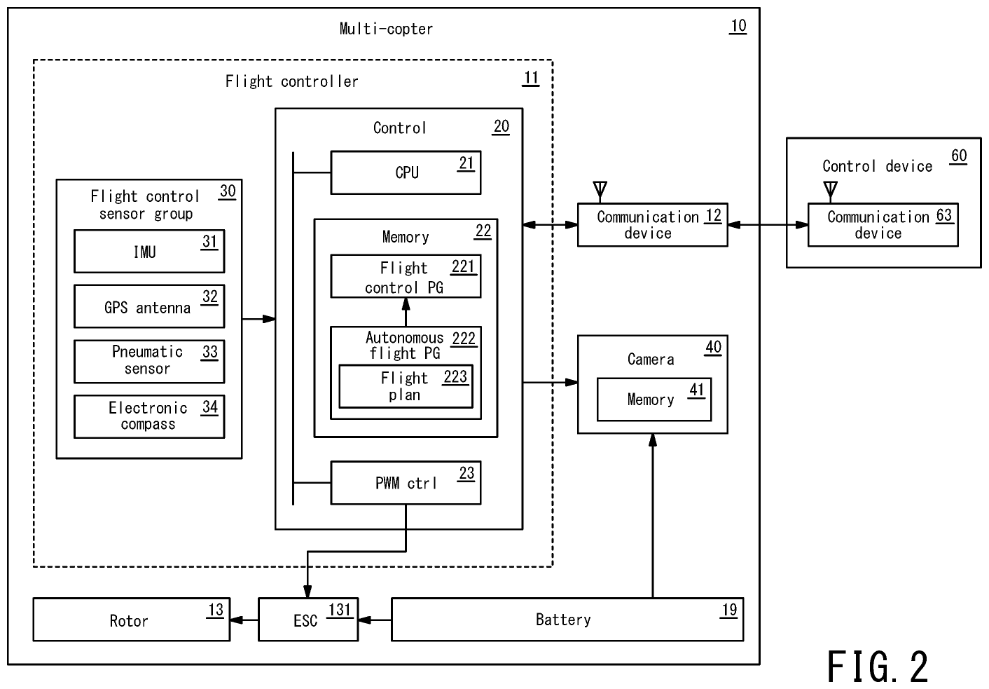

FIG. 2 is a block diagram illustrating a functional configuration of the multi-copter 10. The multi-copter 10 mainly includes: a flight controller 11, which is a control section; a communication device 12, which receives a control signal from the control device 60 carried by an operator and transmits and receives data to and from the control device 60; a plurality of rotors 13, which are brushless motors provided with propellers at a fixed pitch; an ESC 131 (Electric Speed Controller), which is a driving circuit of these rotors 13; a camera 40, which is image pickup means for taking an image of fruit trees and related objects g disposed under the airframe; and a battery 19, which supplies power to the foregoing elements.

The flight controller 11 includes a controller 20, which is a micro-controller. The controller 20 includes: a CPU 21, which is a central processing unit; a memory 22, which is a storage such as ROM, RAM, and flash memory; and a PWM (Pulse Width Modulation) controller 23, which controls the number of rotations of the rotors 13 via the ESC 131.

The flight controller 11 further includes a flight control sensor group 30, which includes: an IMU (Inertial Measurement Unit); a GPS antenna 32; a pneumatic sensor 33; and an electronic compass 34. These elements are connected to the controller 20.

The IMU 31 mainly includes a three-axis acceleration sensor and a three-axis angular velocity sensor. The GPS antenna 32 is, in a strict sense, a receiver in Navigation Satellite System (NSS). The GPS antenna 32 obtains information on present longitude and latitude values and present time from Global Navigation Satellite System (GNSS) or Regional Navigation Satellite System (RNSS). The pneumatic sensor 33 is one embodiment of altitude sensor to measure flight altitude. The pneumatic sensor 33 identifies the flight altitude of the multi-copter 10 by converting an air pressure value that has been detected into a sea level altitude or a relative altitude from the take-off point of the multi-copter 10. It is to be noted that the altitude sensor according to the present invention will not be limited to the pneumatic sensor 33; it is also possible to use the GPS antenna 32 to measure a height from geoid. The electronic compass 34 is one embodiment of direction sensor to measure the azimuth angle of the airframe nose. A three-axis geomagnetic sensor is used as the electronic compass 34 of this example. The controller 20 is capable of obtaining, using the flight control sensor group 30, position information of the airframe, including: the inclination of the airframe; the rotation of the airframe; the longitude and latitude of the airframe in flight; the altitude of the airframe in flight; and the azimuth angle of the airframe nose in flight.

The controller 20 has a flight control program 221, which is a program for controlling the posture of the multi-copter 10 in flight and basic flight motions of the multi-copter 10. The flight control program 221 adjusts the number of rotations of each rotor 13 based on information obtained from the flight control sensor group 30, and makes the multi-copter 10 fly while correcting the posture and/or position of the airframe.

The controller 20 of this example further includes an autonomous flight program 222, which is autonomous flight control means for the multi-copter 10. The autonomous flight program 222 is a program for making the multi-copter 10 fly autonomously based on a flight plan 223, which is setting data including: the path r, on which the multi-copter 10 is made to fly; the altitude a; and speed. As used in the present invention, the “path r” means a flight path on a horizontal plane (defined by longitude and latitude). The autonomous flight program 222 makes the multi-copter 10 fly autonomously based on the flight plan 223, under the starting condition that the operator (the control device 60) makes an execution instruction or time elapses to a predetermined point of time. In this example, this autonomous flight will be referred to as “autopilot”. This example is basically under the assumption that the multi-copter 10 flies by autopilot. It is also possible, however, for the operator to manually operate the multi-copter 10 using the control device 60. Also in this example, the multi-copter 10 is provided with the autonomous flight control means. It may be the control device 60 that is provided with the autonomous flight control means, and autopilot of the multi-copter 10 may be implemented by operating the multi-copter 10 remotely through wireless communication.

While the multi-copter 10 is making a flight, the camera 40 continuously takes still images (performs continuous shooting) of the ground under the airframe at uniform spatial intervals. The images taken by the camera 40 are combined with information on the longitude, latitude, and flight altitude of the multi-copter 10 corresponding to the position at which each image was taken. These pieces of combined information are information obtained by the GPS antenna 32 and the pneumatic sensor 33 of the multi-copter 10. The images are taken at such spatial intervals that some of the fruit trees and related objects g within the field angle of the camera 40 overlap themselves in the direction of progress of the multi-copter 10. These images are analyzed by an image recognition program 721, described later, of the control device 60 so that the distance (ground altitude) between the multi-copter 10 (the camera 40) and the fruit trees and related objects g at the image-pick up position at which each image was taken is calculated. That is, the camera 40 of this example is distance information obtaining means for obtaining information from which the distance between the multi-copter 10 (the camera 40) and the fruit trees and related objects g is measurable. The camera 40 of this example records the images taken and their combined information in a memory 41, such as an SD memory card, of the camera 40. It is also possible, however, to transmit them real-time to the control device 60 through the communication device 12. Also in this example, the camera 40 is used as the distance information obtaining means. The distance information obtaining means according to the present invention, however, may be any other means insofar as the means is capable of obtaining information from which the distance between the unmanned aerial vehicle and the ground surface or the ground object is measurable. Such means may be, other than the camera 40, a laser distance measuring sensor such as an optical distance measuring sensor or an ultrasonic sensor.

### (Functional Configuration of Control Device)

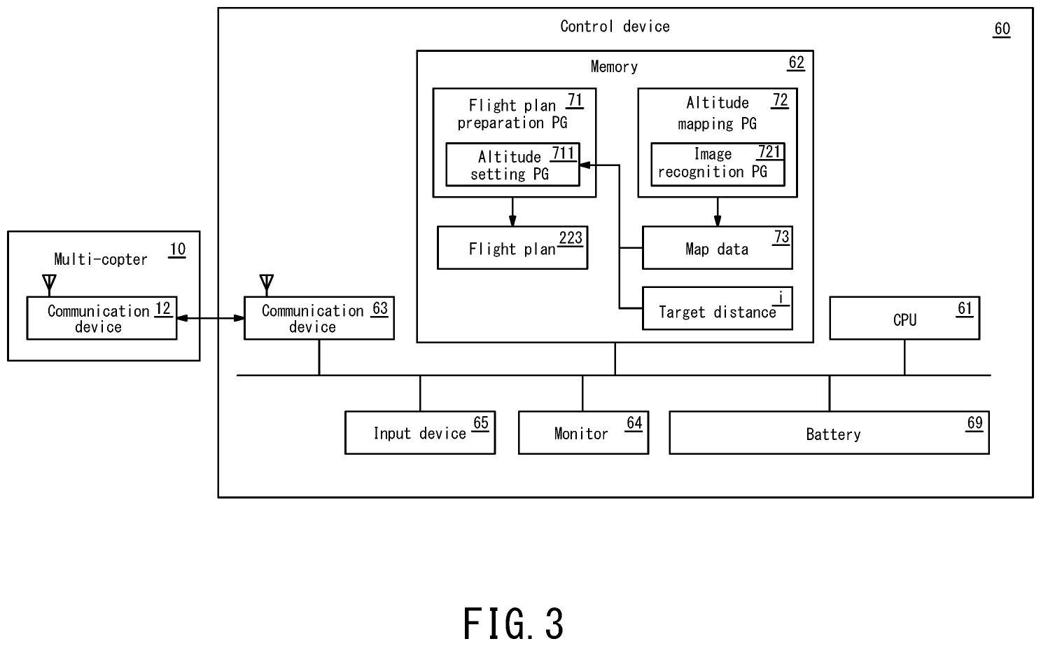

FIG. 3 is a block diagram illustrating a functional configuration of the control device 60. The control device 60 is a terminal with which to perform various kinds of setting associated with the multi-copter 10, monitor the state of the multi-copter 10, and operate the multi-copter 10. In the field of unmanned aerial vehicles, the control device 60 is generally referred to as GCS (Ground Control Station).

The control device 60 mainly includes: a CPU 61, which is a central processing unit; a memory 62, which is a storage such as ROM, RAM, and flash memory; a communication device 63, which is wirelessly communicable with the multi-copter 10; a monitor 64, which visually displays various kinds of information to the operator; an input device 65, which receives an input from the operator; and a battery 69, which supplies power to the foregoing elements.

There is no limitation to communication method and protocol by which the communication device 63 transmits and receives control signals to and from the multi-copter 10. For example, it is possible to use bidirectional Wi-Fi (Wireless Fidelity) communication when uploading the flight plan 223 to the multi-copter 10 and/or receiving telemetry data from the multi-copter 10. For further example, when transmitting an operation signal during manual operation, it is possible to transmit a PCM (pulse code modulation) signal having a bandwidth of 2.4 GHz by frequency hopping. Otherwise, the communication devices 12 and 63 respectively of the multi-copter 10 and the control device 60 may be connection modules connectable to a mobile communication network such as 3G, LTE (Long Term Evolution), and WiMAX (Worldwide Interoperability for Microwave Access). This enables the operator to control the multi-copter 10 from anywhere within a service area of a mobile communication network. Also, the multi-copter 10 and the control device 60 of this example may not necessarily make wireless communication but may make wired communication.

In the control device 60, a flight plan preparation program 71 is installed. The flight plan preparation program 71 is for preparing the flight plan 223 of the multi-copter 10. The operator may use the flight plan preparation program 71 to prepare the flight plan 223 by referring to map data 73, and upload the flight plan 223 to the multi-copter 10.

Further in the memory 62 of the control device 60, the image recognition program 721 is registered. The image recognition program 721 analyzes an image recorded in the memory 41 of the camera 40 to calculate the distance (ground altitude) between the position at which the multi-copter 10 (the camera 40) took the image and the fruit trees and related objects g located under the position. The image recognition program 721 is one embodiment of the distance measuring means according to the present invention.

The image recognition program 721 of this example is a subsidiary program of an altitude mapping program 72, which is one embodiment of the undulation obtaining means according to the present invention. Based on flight altitude information combined with each image and the ground altitude measured by the image recognition program 721, the altitude mapping program 72 calculates the height of the fruit trees and related objects g at the position at which the multi-copter 10 took the image. Then, the altitude mapping program 72 maps heights of the fruit trees and related objects g in the map data 73 based on longitude-latitude information combined with the images.

The flight plan preparation program 71 includes, as a subsidiary program, an altitude setting program 711, which automatically sets an flight altitude in the flight plan 223. The altitude setting program 711 is one embodiment of the altitude setting means according to the present invention. Based on information on the height of the fruit trees and related objects g mapped in the map data 73, the altitude setting program 711 automatically sets the flight altitude a on the path r specified by the operator. As detailed later, the “height” of the fruit trees and related objects g in this example means a relative altitude difference from the take-off point of the multi-copter 10. It is to be noted, however, that this is a way of definition valid when assuming that the multi-copter 10 takes off from the same take-off point when measuring the height of the fruit trees and related objects g and when spraying agricultural chemical. When the multi-copter 10 takes off from different take-off points when measuring the height of the fruit trees and related objects g and when spraying agricultural chemical, it is possible to convert the height of the fruit trees and related objects g that has been measured into a sea-level altitude or into an air pressure value.

Also in the memory 62 of the control device 60, a target distance i is registered. The target distance i is a distance (ground altitude) that should be maintained between the multi-copter 10 and the fruit trees and related objects g at the time of spraying agricultural chemical. The target distance i is a distance specified by the operator. Thus, the memory 62 of the control device 60 is one embodiment of the target distance holding means according to the present invention.

Examples that can preferably be used as the control device 60 include a typical laptop personal computer or a tablet computer. This is because the main elements illustrated in FIG. 3 are integrated in one device, and because the above examples are portable. It is to be noted, however, that there is no limitation to the physical form of the control device 60 according to the present invention insofar as the control device 60 includes the altitude setting means and is capable of preparing a flight plan. For example, separate devices incorporating the main elements illustrated in FIG. 3 maybe combined into the control device 60. Also in this example, the multi-copter 10 and the control device 60 are separate devices. Another possible configuration is that the multi-copter 10 itself has the functions of the control device 60. In this case, the operator may access the control device 60 in the multi-copter 10 using a laptop personal computer or a tablet computer.

### [Method for Setting Flight Altitude]

### (Procedure Outlined)

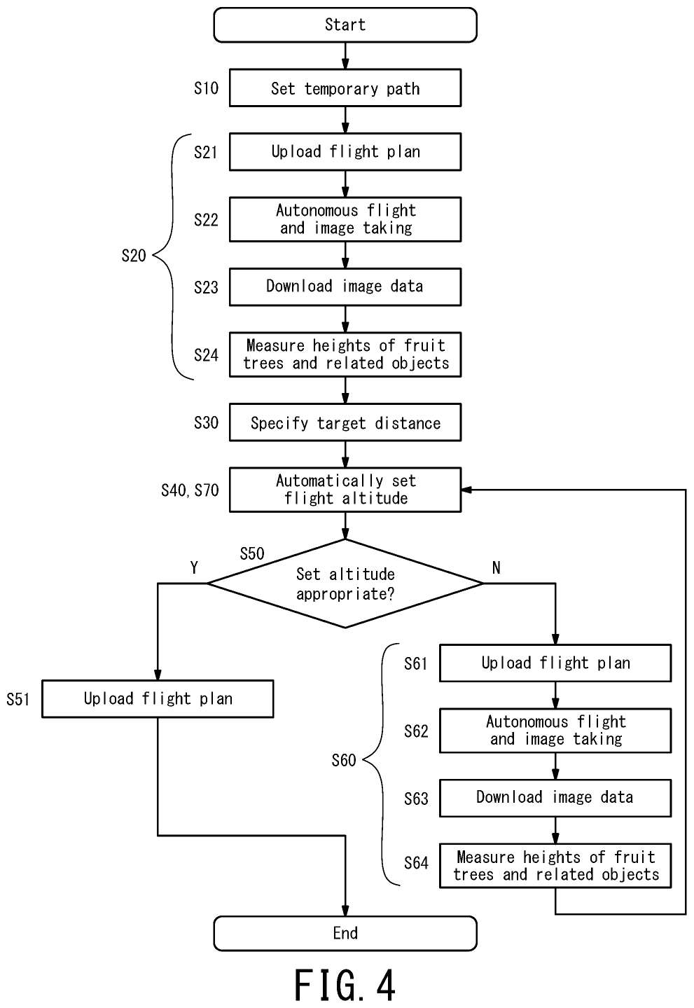

A method of this example for setting a flight altitude will be described below. FIG. 4 is a flowchart of preparation of the flight plan 223. The method of this example for setting a flight altitude mainly includes: temporary path setting step S10, undulation research step S20, target distance setting step S30, and altitude setting step S40. As necessary, undulation re-research step S60 and altitude re-setting step S70 are added to the above steps.

### (Temporary Path Setting Step and Undulation Research Step)

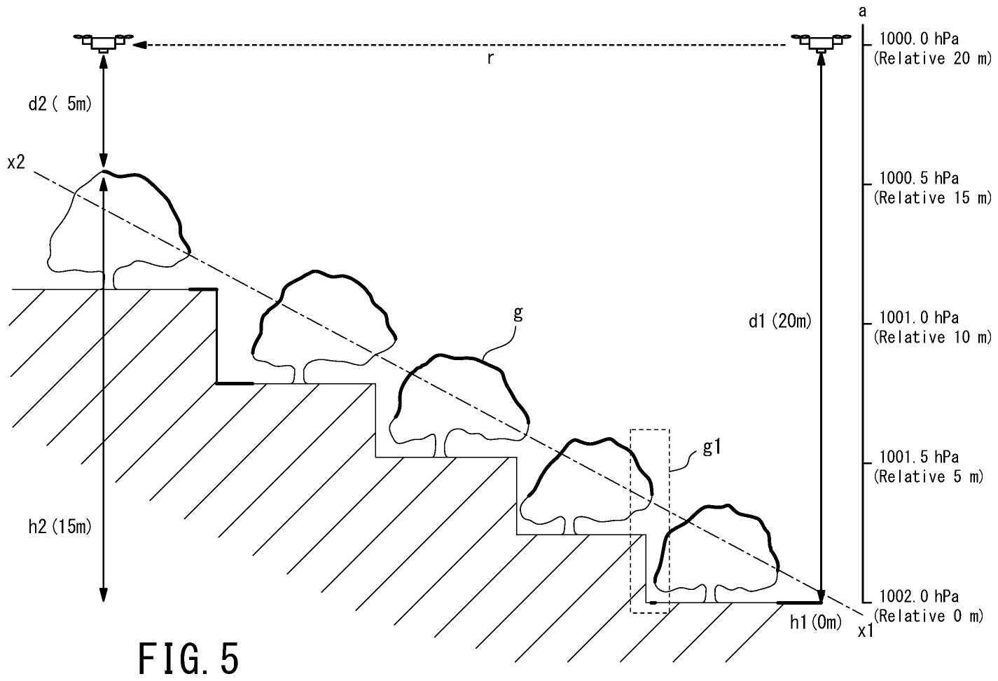

FIG. 5 is a side sectional view of a part cut out from the path r, schematically illustrating the temporary path setting step S10 and the undulation research step S20. At the temporary path setting step S10, the flight plan 223 is prepared. The flight altitude a specified in the flight plan 223 is provided with an allowance relative to the height of the fruit trees and related objects g on the path r. Then, at the undulation research step S20, the multi-copter 10 is made to fly autonomously based on the flight plan 223 and to measure the height of the fruit trees and related objects g on the path r. In this respect, the “flight altitude a provided with an allowance” may be roughly determined based on the operator's visual observation or contour lines on a map. In this example, such flight altitude a may be specified as a relative altitude in excess of 15 m from the take-off point.

The above-described steps will be described in more detail below. The operator first activates the flight plan preparation program 71 of the control device 60, and specifies the path r in the map data 73. Then, the operator visually checks the highest portion of the fruit trees and related objects g on the path r, and sets the flight altitude a on the path r as a whole at 20 m.

The flight altitude a set in the flight plan 223 of this example is obtained by converting the air pressure altitude obtained by the pneumatic sensor 33 of the multi-copter 10 into a relative altitude from the take-off point of the multi-copter 10. In this example, an altitude difference of 1 hPa will be treated as 10 m, for convenience of description. Then at the undulation research step S20, the multi-copter 10 takes off from the lowest position of the fruit trees and related objects g. As illustrated in FIG. 5, the value of the air pressure at the lowest position of the fruit trees and related objects g is 1002.0 hPa. Generally, this air pressure value (1002.0 hPa) indicates a height of about 100 m in sea level. In the multi-copter 10 of this example, this air pressure value (1002.0 hPa) will be regarded as a reference value of the flight altitude a (flight altitude a: 0 m).

Then, the operator uploads the flight plan 223 to the multi-copter 10 from the control device 60 (S21) so as to cause the multi-copter 10 to fly autonomously by autopilot and to take images of the fruit trees and related objects g on the path r using the camera 40 (S22).

Upon completion of the multi-copter 10's autonomous flight on the path r, the operator downloads, from the multi-copter 10 to the control device 60, the images in the memory 41 of the camera 40 and their combined information (S23). Then, the altitude mapping program 72 of the control device 60 analyzes these images and their combined information, and maps the height of the fruit trees and related objects g in the map data 73 (S24).

Among the fruit trees and related objects g, those taken by the camera 40 at the undulation research step S20 and subjected to height measurement are indicated by bold lines in FIG. 5. In this respect, the lowest position of the fruit trees and related objects g is at a distance d1 of 20 m from the image-taking position equivalent to a 20 m (1000.0 hPa) flight altitude a of the multi-copter 10. Thus, the height, hi, of the lowest position of the fruit trees and related objects g is treated as 0 m. The highest position of fruit trees and related objects g is at a distance d2 of 5 m from the image-taking position equivalent to a flight altitude of 20 m. Thus, the height, h2, of the highest position of fruit trees and related objects g is treated as 15 m. In this manner, heights of the fruit trees and related objects g on the path r are measured.

It is to be noted that the line x1-x2 illustrated in FIG. 5 is a line of collinear approximation of heights of the fruit trees and related objects g on the path r. As can be seen from the line x1-x2, the height of the fruit trees and related objects g tends to increase from x1 toward x2 and decrease from x2 toward x1. The line x1-x2 is used to process information on the height of the fruit trees and related objects g on the path r at the altitude setting step S40, which is performed later.

Thus, in the unmanned aerial vehicle system S and the method for setting a flight altitude of this example, the multi-copter 10 includes the pneumatic sensor 33 and the camera 40. With this configuration, the multi-copter 10 subtracts the ground altitude from the flight altitude a of the multi-copter 10 to calculate the height of the fruit trees and related objects g on the flight path r. This ensures that the height of the fruit trees and related objects g is easily measured.

In this example, prior to the work of spraying agricultural chemical, the multi-copter 10 is used to measure the height of the fruit trees and related objects g. This eliminates the need for preparing an additional measuring instrument and/or a related instrument to measure the height of the fruit trees and related objects g. The method of this example, therefore, eliminates labor and cost problems associated with measurement work, and eliminates the problem that measurement data becomes obsolete through the passage of time. Further, undulations and/or inclinations that are as small as a few to several meters in size and that cannot be found on a map or something similar are found on-site, ensuring that flight altitudes a more suitable for actual situations are set.

It is to be noted that the temporary path setting step S10 of this example is not an essential step, and may be omitted. In this case, at the undulation research step S20, the operator may manually operate the multi-copter 10 to obtain the height of the fruit trees and related objects g. It is to be noted, however, that in order to use at the later altitude setting step S40 the measurement result obtained at the undulation research step S20, it is necessary that the height of the fruit trees and related objects g on the path r specified at the altitude setting step S40 has already been measured. That is, at the undulation research step S20, it is necessary to make the airframe fly on the path r specified at the altitude setting step S40; to make the airframe do this by manual operation, skillful pilotage is required. In this respect, it is possible to operate the airframe while checking longitude and latitude values of telemetry data on the control device 60 at hand. This method, however, is not an efficient method.

In this example, the flight plan 223 in which the flight altitude a is provided with an allowance is prepared at the temporary path setting step S10, and the undulation research step S20 itself is performed by autopilot. This ensures that the height of the fruit trees and related objects g along the path r specified at the altitude setting step S40 is efficiently measured. Also, there is a difference between the longitude-latitude information mapped in the map data 73 and the longitude and latitude values detected by the GPS antenna 32. By performing the undulation research step S20 by autopilot, this difference can be understood and adjusted before the work of spraying agricultural chemical.

### (Target Distance Setting Step)

At the target distance setting step S30, the multi-copter 10 specifies the target distance i, which is a distance that should be maintained between the multi-copter 10 and the fruit trees and related objects g when the multi-copter 10 sprays agricultural chemical. In this example, the target distance i is 5 m. The operator is able to specify the target distance i in a desired manner based on the work in which the multi-copter 10 is engaged. This makes the unmanned aerial vehicle system S and the method for setting a flight altitude of this example flexibly usable in a wide range of applications.

### (Altitude Setting Step)

At the altitude setting step S40, the altitude setting program 711 obtains a height by adding the target distance i to the height of the fruit trees and related objects g mapped in the map data 73, and automatically sets the obtained height as the flight altitude a on the path r corresponding to the position of the height. This saves the operator the labor of calculating and inputting an optimum flight altitude a.

It is to be noted that in this example, the path r specified at the temporary path setting step S10 and the path r specified at the altitude setting step S40 are identical to each other. By making these paths r identical to each other, the range of measurement performed at the undulation research step S20 can be narrowed down to a range of measurement actually performed in the agricultural chemical spraying work. This makes the undulation research step S20 efficient and widens the coverage of the range automatically settable at the altitude setting step S40.

Incidentally, if, for example, the height of the ground surface or the ground object changes continuously and smoothly on the path r, the flight altitude a may be obtained simply by adding the target distance i to the height of the fruit trees and related objects g. In this example, however, the height of the fruit trees and related objects g frequently fluctuates within a narrow range. In this case, the mere addition of the target distance i to the height of the fruit trees and related objects g leaves the problem that the flight altitude a of the multi-copter 10 is instable. For example, the height of the fruit trees and related objects g fluctuates in area g1 defined by broken lines in FIG. 5 If a flight altitude a is obtained by adding the target distance i to the height of the fruit trees and related objects g and the multi-copter 10 is made to fly at this flight altitude a, the multi-copter 10 is made to alternate between downward movement and upward movement in approximately vertical directions in the area g1.

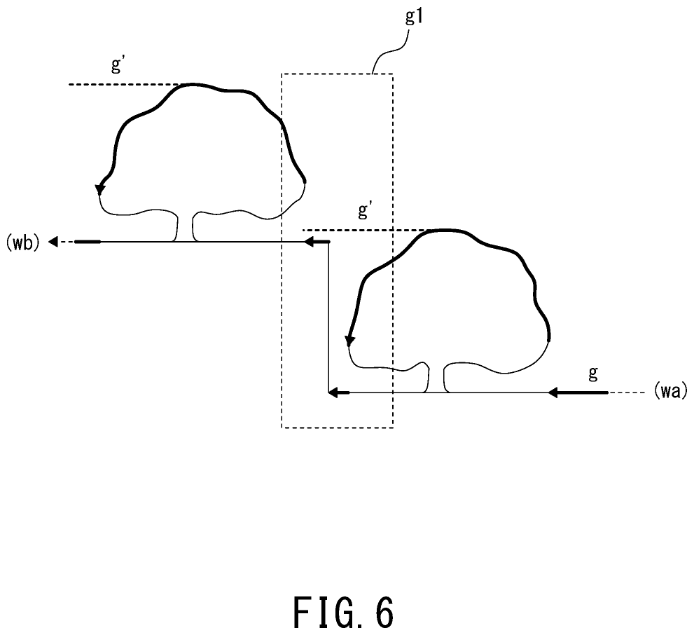

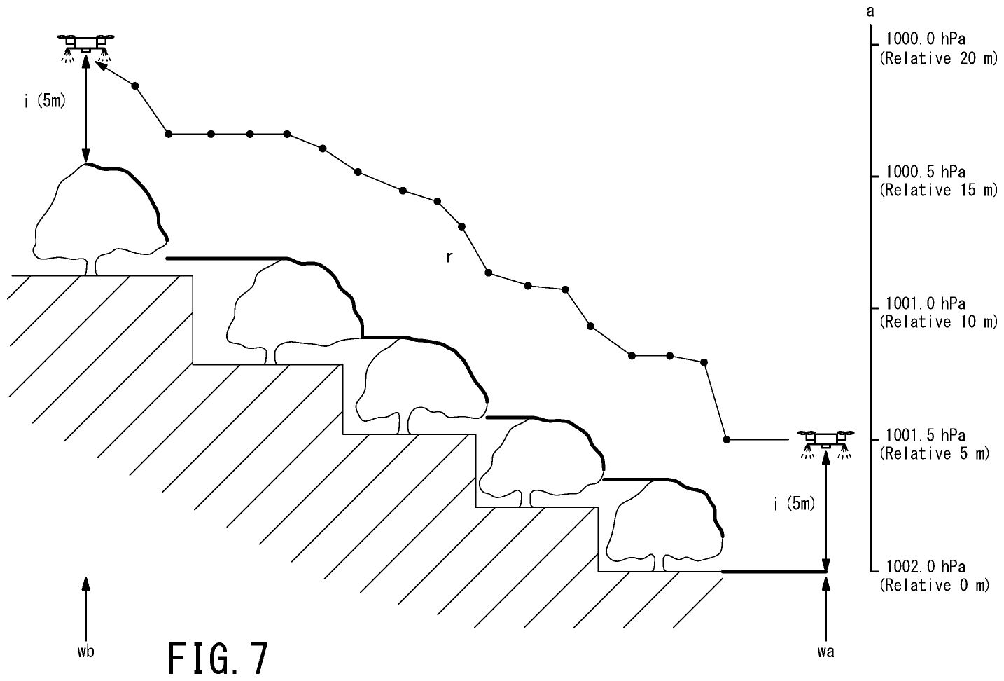

FIGS. 6 and 7 are schematics illustrating examples in which information on the height of the fruit trees and related objects g mapped in the map data 73 is processed. FIG. 6 is a partially enlarged view of a part cut out from FIG. 5, illustrating a method of processing the information on the height of the fruit trees and related objects g in a case where the height of the fruit trees and related objects g tends to increase in the direction of progress on the path r. FIG. 7 illustrates a state in which the flight altitude a is automatically set after the information on the height of the fruit trees and related objects g illustrated in FIG. 5 has been processed.

In the examples illustrated in FIGS. 6 and 7, the path r specified by the operator is directed from a waypoint wa toward a waypoint wb. As used herein, the term “waypoint” refers to an intermediate point on the path r. The flight plan preparation program 71 sets the path r such that waypoints are arranged in the order in which the operator specified the waypoints in the map data 73 and that the waypoints are connected to each other.

As described above by referring to FIG. 5, in the direction from the waypoint wa toward the waypoint wb, that is, in the direction from x1 toward x2, the height of the fruit trees and related objects g tends to increase. In this section, the operation of decreasing the flight altitude a of the multi-copter 10 would presumably have more negative effects than positive effects. This is because if the flight altitude a of the multi-copter 10 is decreased along the height of the fruit trees and related objects g, it is necessary to rapidly move the multi-copter 10 upward immediately after decreasing the flight altitude a, leaving a possibility of collision with the fruit trees and related objects g.

In light of this, as illustrated in FIG. 6, the altitude setting program 711 of this example processes the information on the height of the fruit trees and related objects g mapped in the map data 73. Specifically, the altitude setting program 711 first scans the height of the fruit trees and related objects g in the direction from the waypoint wa toward the waypoint wb. Then, when the height of one portion of the fruit trees and related objects g has become lower than the height of the immediately previous portion of the fruit trees and related objects g, the altitude setting program 711 changes the height of the one portion to the maximum height of a previous portion (broken lines g′). By this processing, the information on the height of the fruit trees and related objects g in the direction from the waypoint wa toward the waypoint wb is processed from the state indicated by the bold lines in FIG. 5 to the state indicated by the bold lines in FIG. 7. Then, the altitude setting program 711 adds the target distance i to the processed height of the fruit trees and related objects g, thereby setting the flight altitude a on the path r. It is to be noted that the intervals at which the altitude setting program 711 sets intermediate points al of the flight altitude a may be adjusted in a desired manner based on the accuracy required in the application in which the multi-copter 10 is used.

Also, on the path in the direction opposite to the direction of progress illustrated in FIGS. 6 and 7, that is, on the path in the direction from the waypoint wb toward the waypoint wa, the height of the fruit trees and related objects g tends to decrease, as indicated by the line x1-x2 in FIG. 5. In this section as well, the operation of rapidly moving the multi-copter 10 upward immediately after decreasing the flight altitude a of the multi-copter 10 would presumably make little sense. Therefore, in this case as well, it is preferable to turn the information on the height of the fruit trees and related objects g into the state illustrated in FIG. 7 and then add the target distance i to the resulting height of the fruit trees and related objects g.

In light of the considerations above, the altitude setting program 711 of this example collinearly approximates the heights of the fruit trees and related objects g between the waypoints specified by the operator, and performs the processing illustrated in FIG. 6 between the waypoints in the direction in which the height of the fruit trees and related objects g increases. This eliminates or minimizes unnecessary high-low differences on the path r as a whole, making flight motions of the multi-copter 10 more stable.

Then, when the altitude in the flight plan 223 prepared through the altitude setting step S40 is appropriate in the eyes of the operator (S50: Y), the altitude setting program 711 uploads the flight plan 223 to the multi-copter 10 and prepares for agricultural chemical spraying.

In contrast, when the accuracy of measurement performed at the undulation research step S20 is insufficient, the image recognition program 721, the altitude mapping program 72, or the altitude setting program 711 may display an alert or a warning on the monitor 64. Also, if a rapid upward movement or a rapid downward movement at some position on the path is in a level that exceeds a predetermined threshold, it is possible to propose that the multi-copter 10 circumvent the position.

### (Undulation Re-Research Step and Altitude Re-Setting Step)

As described earlier, if the measurement at the undulation research step S20 is performed only once, it is possible that the flight altitude a that has been set is not sufficiently accurate, depending on the accuracy of measurement performed at the undulation research step S20 (S50: N). In this case, it is possible to measure again the height of the fruit trees and related objects g using the flight plan 223 prepared at the altitude setting step S40. This ensures that a measurement result higher in accuracy than the previous measurement result is obtained.

At the undulation re-research step S60, the multi-copter 10 is made to fly autonomously based on the flight plan 223 prepared at the altitude setting step S40 and to measure the height of the fruit trees and related objects g on the path r in the flight plan 223. This is performed according to a procedure equivalent to the undulation research step S20, which was performed first.

The operator uploads the flight plan 223 to the multi-copter 10 from the control device 60 (S61) so as to cause the multi-copter 10 to fly autonomously by autopilot and to take images of the fruit trees and related objects g on the path r using the camera 40

Upon completion of the multi-copter 10's autonomous flight on the path r, the operator downloads, from the multi-copter 10 to the control device 60, the images in the memory 41 of the camera 40 and their combined information (S63). Then, the altitude mapping program 72 of the control device 60 analyzes these images and their combined information, and maps the height of the fruit trees and related objects g in the map data 73 (S64).

The procedure for the altitude re-setting step S70 is equivalent to the altitude setting step S40. The altitude setting program 711 automatically sets the flight altitude a on the path r based on the height information measured at the undulation re-research step S60 and mapped in the map data 73.

Then, when the altitude in the flight plan 223 prepared through the altitude re-setting step S70 is appropriate in the eyes of the operator (S50: Y), the altitude setting program 711 uploads the flight plan 223 to the multi-copter 10 and prepares for agricultural chemical spraying. If, at this point of time, the accuracy of the flight altitude a is not sufficient, the undulation re-research step S60 and the altitude re-setting step S70 may be performed again.

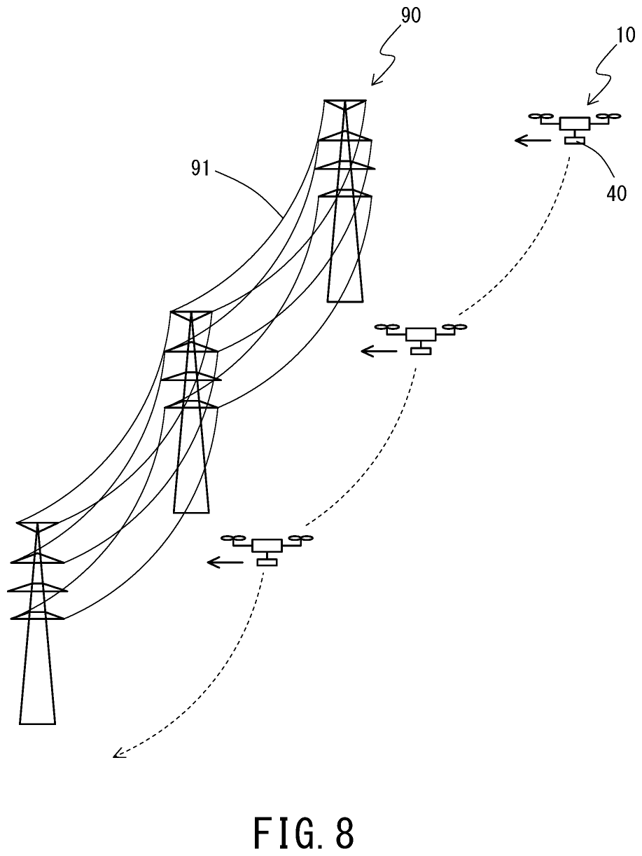

Thus, the unmanned aerial vehicle system S and the method for setting a flight altitude of this example efficiently implement an autonomous flight along an uneven ground and an inclined surface, which is difficult to implement with a typical flight controller product.

[Other Application Examples] FIG. 8 is a schematic illustrating an example in which the unmanned aerial vehicle system S of this example is used in another application. FIG. 8 illustrates an example of work in which the multi-copter 10 is made to: fly along the looseness of power-transmission lines 91, which have been stretched between steel towers 90 using the unmanned aerial vehicle system S; and take images of the power-transmission lines 91 from one side of them.

Power-transmission lines and distribution lines on overhead electric line paths are provided with a predetermined degree of looseness (looseness) for the purpose of protecting electric lines, steel towers, and utility poles. Thus, in order to, for example, inspect an electric line for damage, an unmanned aerial vehicle is made to fly along the electric line and take images of the electric line from one side of the electric line. In this respect, it is necessary to adjust the flight altitude of the unmanned aerial vehicle based on the looseness of the electric line. To implement such flight manually, a high level of pilotage is required of the operator, leaving a problem in securing skilled workers.

Description will be made below with regard to an image-taking procedure for taking images of the power-transmission line 91 using the unmanned aerial vehicle system S. At the temporary path setting step S10, a flight plan 223 is prepared in which the multi-copter 10 is made to fly immediately above the power-transmission line 91 along the power-transmission line 91. At the undulation research step S20, the camera 40 is made to take images of the power-transmission line 91 from immediately above the power-transmission line 91, and heights of the power-transmission line 91 at some positions on the power-transmission line 91 are measured. At the target distance setting step S30, the target distance i is set at 0 m. At the altitude setting step S40, the flight altitude a is automatically set without processing the measured heights of the power-transmission line 91 (if the accuracy of measurement of the heights of the power-transmission line 91 is insufficient, the undulation re-research step S60 and the altitude re-setting step S70 are performed again). Then, the path r in the flight plan 223 prepared through the altitude setting step S40 is manually moved by a distance optimum for taking images of the power-transmission line 91. Then, the multi-copter 10 is made to fly autonomously with the camera 40 pointed at the power-transmissionline 91. It is to be noted that when the autonomous flight program 222 is capable of controlling ON/OFF, PTZ, and/or other functions of the camera 40, the flight plan 223 may control the orientation of the camera 40.

While an embodiment of the present invention has been described hereinabove, the scope of the present invention will not be limited to the above-described embodiment, and various changes may be made without departing from the gist of the invention. For example, the unmanned aerial vehicle usable in the method according to the present invention for setting a flight altitude and the unmanned aerial vehicle system according to the present invention will not be limited to the multi-copter 10; the present invention is also applicable to helicopters, fixed-wing vehicles, and even VTOL (Vertical Take-Off and Landing) vehicles, insofar as these vehicles are unmanned. Also, the application in which the method according to the present invention for setting a flight altitude and the unmanned aerial vehicle system according to the present invention are usable will not be limited to agricultural chemical spraying and taking images of electric lines; the present invention is usable in any other applications in which it is necessary to control flight altitude along the height of a ground surface or a ground object. As used in the present invention, “a (the) ground surface or a (the) ground object” will not be limited to natural objects but encompasses indoor and outdoor artificial objects such as floor surfaces, stairs, and furniture and fixtures disposed on floors.

1. A method for setting a flight altitude of an unmanned aerial vehicle, the method comprising:
an undulation research step of making the unmanned aerial vehicle fly and measuring a height of a ground surface or a ground object; and
an altitude setting step of, during preparation of a flight plan that is setting data including a specification of a path on which the unmanned aerial vehicle is made to fly autonomously, automatically setting the flight altitude on the path in the flight plan based on the height of the ground surface or the ground object measured in the undulation research step.

2. The method according to claim 1 for setting the flight altitude of the unmanned aerial vehicle, wherein the undulation research step comprises measuring the height of the ground surface or the ground object based on: a sea level altitude obtained using an altitude sensor with which the unmanned aerial vehicle is equipped or a relative altitude measured from a take-off point of the unmanned aerial vehicle and obtained using the altitude sensor; and a ground altitude obtained using a distance measuring sensor or image pickup means facing downward from the unmanned aerial vehicle.

3. The method according to claim 1 for setting the flight altitude of the unmanned aerial vehicle, further comprising a temporary path setting step of preparing a flight plan in which the path on which the unmanned aerial vehicle is made to fly autonomously is specified such that the flight altitude is provided with an allowance relative to the height of the ground surface or the ground object on the path,
wherein the undulation research step comprises making the unmanned aerial vehicle fly autonomously based on the flight plan prepared in the temporary path setting step and measuring the height of the ground surface or the ground object on the path in the flight plan.

4. The method according to claim 3 for setting the flight altitude of the unmanned aerial vehicle, wherein the path in the flight plan prepared in the temporary path setting step and the path in the flight plan prepared in the altitude setting step are approximately identical to each other in longitude and latitude.

5. The method according to claim 1 for setting the flight altitude of the unmanned aerial vehicle, further comprising a target distance setting step of specifying a target distance that is a ground altitude for the unmanned aerial vehicle to maintain,
wherein the altitude setting step comprises automatically setting, as the flight altitude on the path in the flight plan, a height obtained by adding the target distance to the height of the ground surface or the ground object measured in the undulation research step.

6. The method according to claim 5 for setting the flight altitude of the unmanned aerial vehicle, further comprising:
an undulation re-research step of making the unmanned aerial vehicle fly autonomously based on the flight plan prepared in the altitude setting step and measuring the height of the ground surface or the ground object on the path in the flight plan; and
an altitude re-setting step of automatically setting, as the flight altitude on the path in the flight plan, a height obtained by adding the target distance to the height of the ground surface or the ground object measured in the undulation re-research step.

7. The method according to claim 1 for setting the flight altitude of the unmanned aerial vehicle, wherein a path along an inclined surface is specified in the flight plan prepared in the altitude setting step.

8. An unmanned aerial vehicle system comprising:
an unmanned aerial vehicle; and
a control device configured to prepare a flight plan that is setting data including a specification of a path on which the unmanned aerial vehicle is made to fly autonomously,
wherein the unmanned aerial vehicle or the control device comprises
autonomous flight control means for making the unmanned aerial vehicle fly autonomously based on the flight plan, and
undulation obtaining means for calculating a height of a ground surface or a ground object on the path on which the unmanned aerial vehicle has been made to fly, and
wherein the control device comprises altitude setting means for, during preparation of the flight plan, automatically setting a flight altitude of the unmanned aerial vehicle on the path in the flight plan based on the height of the ground surface or the ground object calculated by the undulation obtaining means.

9. The unmanned aerial vehicle system according to claim 8,
wherein the unmanned aerial vehicle comprises
an altitude sensor configured to obtain a sea level altitude or a relative altitude measured from a take-off point, and
distance information obtaining means for obtaining information from which a distance to the ground surface or the ground object is measurable,
wherein the unmanned aerial vehicle or the control device comprises distance measuring means for calculating a ground altitude of the unmanned aerial vehicle from the information obtained by the distance information obtaining means, and
wherein the undulation obtaining means is configured to calculate the height of the ground surface or the ground object based on the sea level altitude or the relative altitude from the take-off point obtained by the altitude sensor and based on the ground altitude obtained by the distance measuring means.

10. The unmanned aerial vehicle system according to claim 8,
wherein the control device comprises target distance holding means for storing a target distance that is a ground altitude for the unmanned aerial vehicle to maintain, and
wherein the altitude setting means is configured to automatically set, as the flight altitude on the path in the flight plan, a height obtained by adding the target distance to the height of the ground surface or the ground object.
